(19) United States
(12) Patent Application Publication
(10) Pub. No.: US 2018/0082310 A1
(43) Pub. Date: Mar. 22, 2018

(54) IDENTIFICATION OF REGIONS INCLUDING UNAUTHORIZED PRODUCTS

(71) Applicant: Hewlett-Packard Development Company, L.P., Houston, TX (US)

(72) Inventors: Shell S. Simpson, Boise, ID (US); Paul L. Jeran, Boise, ID (US)

(21) Appl. No.: 15/823,112

(22) Filed: Nov. 27, 2017

Related U.S. Application Data
(63) Continuation of application No. 13/033,000, filed on Feb. 23, 2011, now abandoned.

(51) Int. Cl. G06Q 30/00

(52) U.S. Cl. CPC G06Q 30/018

(57) ABSTRACT

Methods and apparatus to identify regions including unauthorized products are disclosed. A processor is to access a request for verification of authenticity of a product transmitted from a remote computing device. The request includes verification data and location data. The location data is based on global positioning satellite information generated by the remote computing device at a time when the remote computing device generates the verification data based on a verification code printed on the product. The processor is to determine whether a particular region including the physical location has at least a threshold likelihood of being a region in which unauthorized products are available. The processor is to construct boundaries of the particular region to 1) have less than a first area and 2) include at least a threshold number of invalid requests for verification within the boundaries.

### RELATED APPLICATIONS

This patent arises from a continuation of U.S. patent application Ser. No. 13/033,000, which was filed on Feb. 23, 2011, and which is incorporated herein by reference in its entirety.

### BACKGROUND

When a customer, reseller, or other party acquires a product, it is generally expected that the product will conform to a minimal level of quality. For example, the acquiring party may expect that the product originated from a particular manufacturer or reseller and that the product performs to an acceptable level. When the product is of inferior quality or did not originate from the particular manufacturer, the acquiring party may be dissatisfied and experience negative effects.

### BRIEF DESCRIPTION OF THE DRAWINGS

The following detailed description references the drawings, wherein:

FIG. 1 is a block diagram of an example computing device for identifying regions in which unauthorized products are available;

FIG. 2 is a block diagram of an example computing device for identifying regions in which unauthorized products are available using predetermined region data or dynamic region data;

FIG. 3 is a flowchart of an example method for identifying regions in which unauthorized products are available;

FIG. 4A is a flowchart of an example method for identifying regions in which unauthorized products are available using predetermined boundaries;

FIG. 4B is a flowchart of an example method for identifying regions in which unauthorized products are available using dynamic region boundaries;

FIG. 5A is a diagram illustrating example predetermined vendor boundaries and a plurality of corresponding verification requests; and

FIG. 5B is a diagram illustrating example dynamic vendor boundaries and a plurality of corresponding verification requests.

### DETAILED DESCRIPTION

As detailed above, a party acquiring a packaged product generally expects that the product contained within the package is properly represented prior to acquisition. This could include an expectation of a minimum level of quality and that the product originated from a particular manufacturer, reseller, or other source. Unfortunately, it is often difficult for the manufacturer or other originator of the product to ensure that customers or other parties are receiving authentic, high quality goods.

To address these issues, example embodiments disclosed herein provide for identification of geographical regions suspected to include unauthorized products. For example, a computing device may receive a request for verification of authenticity of a product from a potential purchaser or other party. This request may include a verification code printed on the product and location data identifying a physical location of the product In response to the request, the computing device may analyze the request to determine whether a region including the physical location of the product is likely to be a region in which unauthorized products are available.

In this manner, example embodiments disclosed herein allow an entity to efficiently identify locations likely to include unauthorized products. Because these requests may be provided by customers or other individuals at a geographical location in the ordinary course of business, suspect locations may be identified with minimal effort. Embodiments disclosed herein thereby allow a manufacturer or other party to increase customer satisfaction. Additional embodiments and applications of such embodiments will be apparent to those of skill in the art upon reading and understanding the following description.

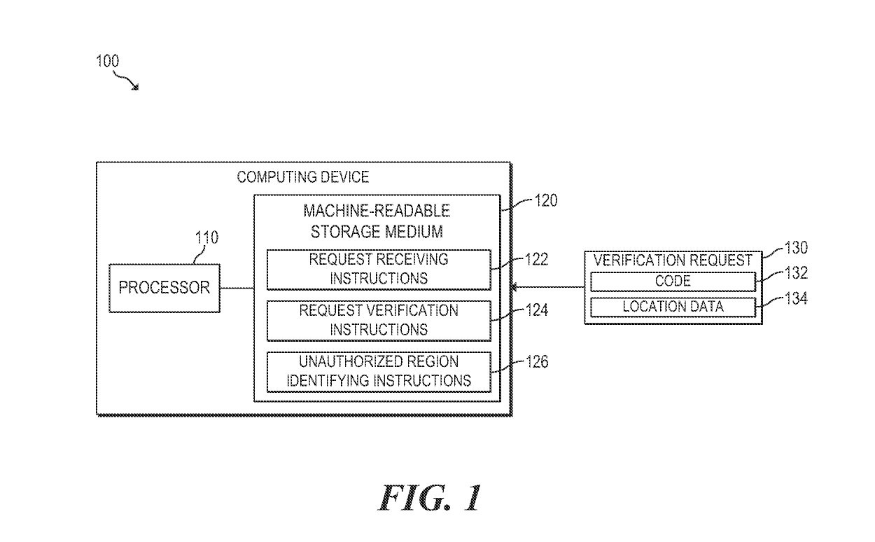

Referring now to the drawings, FIG. 1 is a block diagram of an example computing device 100 for identifying regions in which unauthorized products are available. Computing device 100 may be, for example, a workstation, a server, a notebook computer, a desktop computer, an all-in-one system, a slate computing device, or any other computing device suitable for execution of the functionality described below. In the implementation of FIG. 1, computing device 100 includes processor 110 and machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126 to implement the procedure for identifying unauthorized regions, as described below. As an alternative or in addition to retrieving and executing instructions, processor 110 may include one or more electronic circuits that include a number of electronic components for performing the functionality of one or more of instructions 122, 124, 126.

Machine-readable storage medium 120 may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage drive, a Compact Disc Read-Only Memory (CD-ROM), and the like. As described in detail below, machine-readable storage medium 120 may be encoded with executable instructions for identifying regions likely to include unauthorized products.

Request receiving instructions 122 may receive a number of requests 130 for verification of authenticity of a corresponding product. Each request 130 may include a verification code 132 printed on the product and location data 134 identifying a physical location of the product. As detailed below, in response to receipt of such a request, computing device 100 may perform processing to determine whether the corresponding product is authentic or, alternatively, is an unauthorized product. Computing device 100 may then determine whether the geographical region including location data 134 is a region likely to include unauthorized products.

The verification code 132 may be any unique code assigned to a particular product sufficient to confirm the authenticity of the product. For example, a manufacturer may generate and print a unique code on each product at the time of manufacturing, packaging, or shipping of the product and store these codes in a database for a subsequent lookup. Accordingly, each product may be associated with a particular code, such that the code may be subsequently used to verify that the particular product did in fact originate from the manufacturer and that the product is therefore authentic and is currently located in an authorized location.

Code 132 may be printed on the packaging of the product or otherwise placed in a location such that customers may access the unique code while at a vendor's physical location. The product may be, for example, a printer toner or ink cartridge, a multimedia disc (e.g., a video disc, music disc, or video game), a gift card, or any other item that is produced by a manufacturer or other entity. To give a specific example of a code, code 132 may be a bar code or encoded image printed on the outside of the packaging, on a tag, or in some other readily-accessible location. Alternatively, code 132 may be a string of alphanumeric characters, such as a number, word, or combination of numbers and letters.

Location data 134 may be any information sufficient to identify the physical location of the product when the customer or other party provides code 132 to computing device 100. For example, location data 134 may be a set of Global Positioning Satellite (GPS) coordinates obtained using GPS hardware included in a computing device of the customer or other party inspecting the product. In such embodiments, when scanning or otherwise receiving entry of code 132, the customer's computing device may utilize its GPS hardware to determine a current GPS location and may then forward this location to computing device 100 as location data 134. As another example, location data 134 may be a mailing address including a street address and zip code sufficient to identify the actual location. In such embodiments, the customer or other party may enter the mailing address into his or her computing device for transmission to computing device 100 as location data 134. As yet another example, location data 134 may be a unique code assigned to a particular location or seller.

In practice, a customer or other party situated at a given location may physically manipulate the product to view the verification code 132. The customer or other party may then use his or her personal computing device, such as a cell phone or laptop computer, to transmit verification code 132 and location data 134 to computing device 100 along with a verification request 130. Alternatively, this process may be included as part of the checkout procedure at the vendor, such that a cashier or other employee scans or otherwise enters verification code 132.

Regardless of the methodology used for transmission of request 130, upon receipt of the request, computing device 100 may trigger request verification instructions 124, which may determine whether each received request is valid using code 132. In embodiments in which computing device 100 maintains a record of all valid codes, computing device 100 may simply perform a database lookup to determine whether the received code 132 is included in the record of valid codes. Alternatively, computing device 100 may perform a mathematical operation, such as a hash operation, to determine the validity of the received code.

In some embodiments, in determining whether a request is valid, verification instructions 124 may also determine whether the corresponding product is currently located in a permitted location. For example, a database accessible to computing device 100 may include, for each verification code, data identifying one or more locations at which the corresponding product is authorized to be sold, distributed, or otherwise located. Each valid location may be defined using, for example, a set of GPS coordinates defining a boundary or an address, such as a street address and/or zip code or country.

Upon receipt of a verification request 130, instructions 124 may identify code 132 and, assuming the code 132 is valid, look up the geographical locations at which the corresponding product is permitted to be located. Instructions 124 may then determine, using location data 134, whether the product is currently located within the permitted geographical area. If so, instructions 124 may determine that the request 130 is valid and may otherwise determine that the request 130 is invalid. In this manner, verification instructions 124 may also be used to identify gray market products that have been traded through distribution channels unintended by the manufacturer or other originator of the product.

Upon determination of the validity of the request 130, instructions 124 may notify the customer or other transmitting entity of the validity of the received product code 132. In this manner, the customer or other party may assess the authenticity of the product while at the physical location and may also determine whether the product is permitted to be at the physical location. Additionally, instructions 124 may notify unauthorized region identifying instructions 126 of the validity determination.

Unauthorized region identifying instructions 126 may then identify regions likely to include unauthorized products based on the product verification results determined by instructions 124. For example, identifying instructions 126 may group invalid requests into regions based on the physical location identified by the location data 134 included with each request. In this manner, identifying instructions 126 may identify areas with high concentrations of invalid requests, thereby indicating that the region is likely to have a relatively high proportion of unauthorized products.

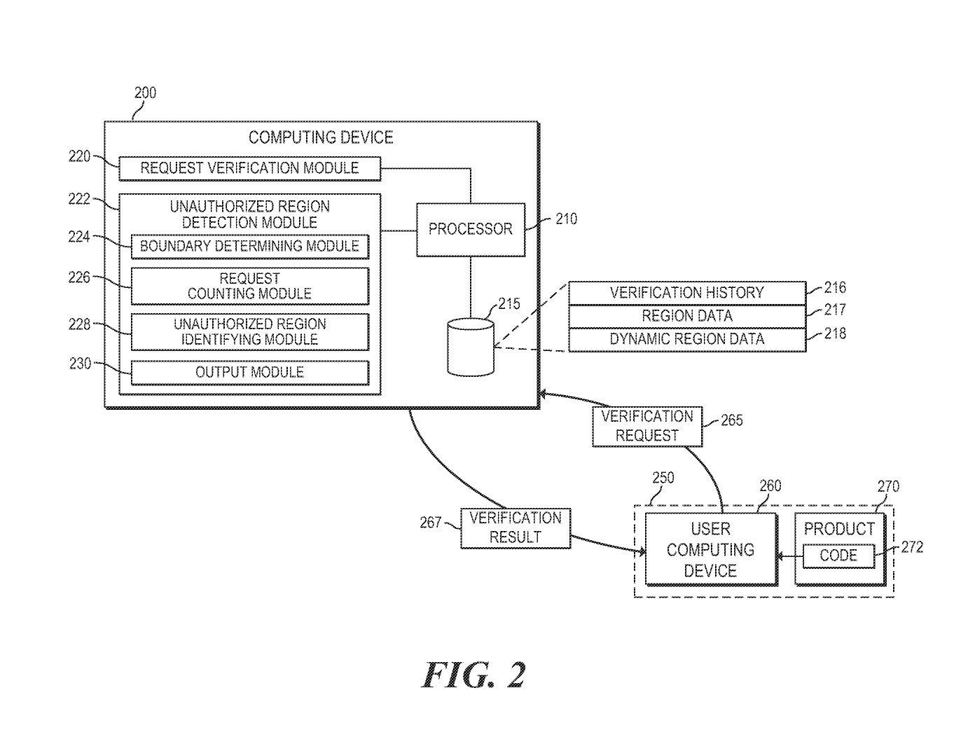

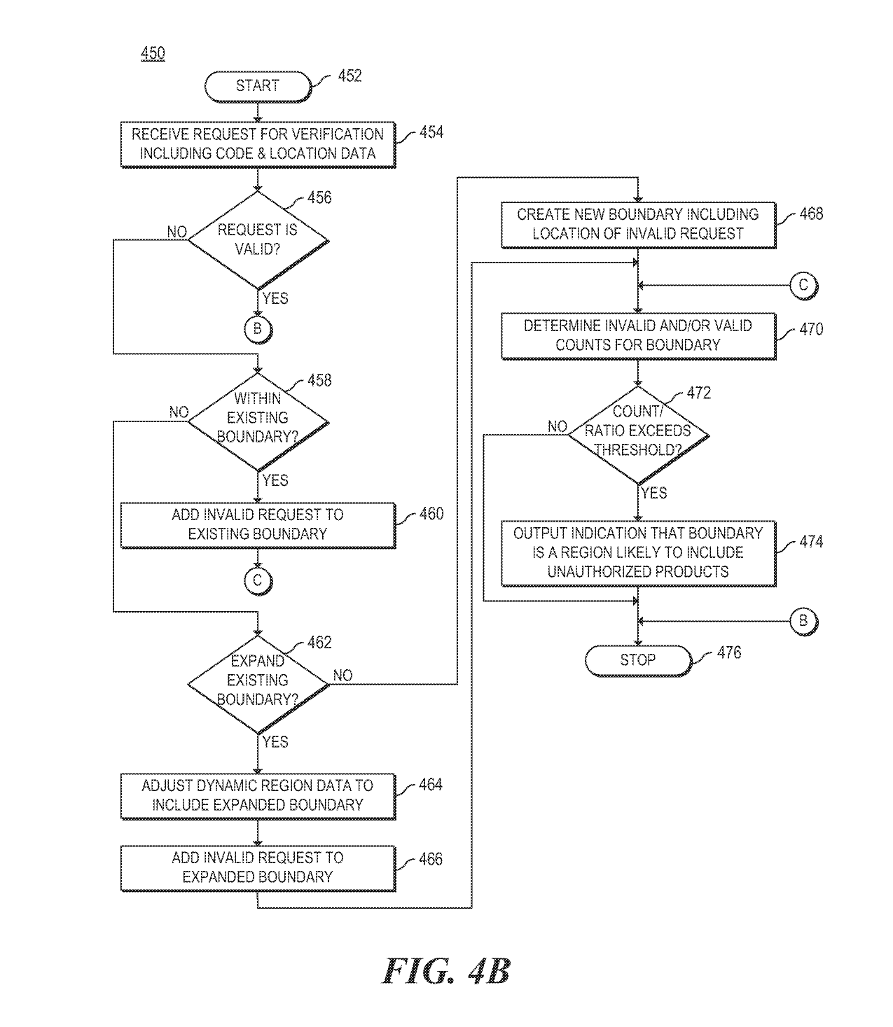

The particular methodology used for identifying regions likely to include unauthorized products may vary by embodiment. In some embodiments, unauthorized region identifying instructions 126 may map invalid requests to predetermined geographical boundaries for each location, which may be the location of a given vendor. These boundaries may be determined using, for example, a database including map data outlining the physical premises of each vendor. Invalid requests may then be attributed to a particular vendor when the location data 134 of the particular request falls within the predetermined boundary of the vendor. Additional details regarding this method are provided below in connection with FIG. 2 and method 400 of FIG. 4A.

In other embodiments, unauthorized region identifying instructions 126 may dynamically maintain geographical region boundaries in a manner that maximizes the number of invalid requests that include location data 134 within the boundaries. This process may be subject to a maximum boundary size, which may be a predetermined value equal to an estimated maximum area occupied by a vendor or other party in possession of the particular product. In this manner, as invalid requests are identified, instructions 126 may create and adjust boundaries that encompass the invalid requests.

Using this methodology, each resulting geographical boundary will likely roughly correspond to the premises of a given vendor or other party in possession of the product. Advantageously, this method allows for identification of any vendor or other party, even when the location is unknown prior to the identification procedure. This method therefore allows for identification of street or park vendors or other parties that do not publicly share their location. Additional details regarding this method are provided below in connection with FIG. 2 and method 450 of FIG. 4B.

FIG. 2 is a block diagram of an example computing device 200 for identifying regions in which unauthorized products are available using predetermined region data 217 or dynamic region data 218. As detailed below, computing device 200 may be in communication with user computing device 260 for receiving and processing verification requests 265.

As with processor 110 of FIG. 1, processor 210 may be a CPU or microprocessor suitable for retrieval and execution of instructions and/or one or more electronic circuits configured to perform the functionality of one or more of the modules 220-230 described below. Computing device 200 may also include a storage module 215, which may store data under the direction of processor 210. For example, storage module 215 may include one or more hard disks, solid state drives, tape drives, nanodrives, holographic storage devices, or any combination of such storage devices. Each of these storage devices may be included in computing device 200 or located remotely from computing device 200.

In operation, storage module 215 may maintain verification history 216, region data 217, and/or dynamic region data 218. Verification history 216 may be a record detailing received verification requests and the resulting determination for each of the requests. For example, each record in verification history 216 may store a verification code, a corresponding product identifier (e.g., a Universal Product Code), the physical location from which the particular verification request originated, and the verification result (e.g., valid or invalid). As detailed below, unauthorized region identifying module 228 may access verification history 216 when identifying regions likely to include unauthorized products.

Storage module 215 may also maintain region data, which may vary depending on the particular embodiment. In embodiments in which identifying module 228 utilizes predetermined boundaries, region data 217 may store these predetermined boundaries for each of a plurality of vendors or other locations. For example, region data 217 may store, for each vendor, a vendor identifier (e.g., a name, numerical ID, etc.) and a corresponding set of GPS coordinates that define the outer boundaries of the vendor. As an alternative, region data 217 may store an address of the vendor, such as a street address and zip code. Alternatively, in embodiments in which identifying module 228 utilizes dynamic vendor boundaries, dynamic region data 218 may similarly define each of a plurality of outer boundaries as a set of GPS coordinates defining the outer boundaries of the dynamic region.

In addition to the data defining the boundaries, region data 217 and dynamic region data 218 may also store values indicating the number of valid and/or invalid verification requests that fall within each region, as determined by request counting module 226. In this manner, as detailed below, identifying module 228 may identify regions likely to include unauthorized products based on the counts of invalid and valid requests.

As detailed below, computing device 200 may include a series of modules 220-230 for verifying requests and detecting regions including unauthorized products. Each of the modules may include, for example, one or more hardware devices including electronic circuitry for implementing the functionality described below. In addition or as an alternative, each module may be implemented as a series of instructions encoded on a machine-readable storage medium of computing device 200 and executable by processor 210.

Request verification module 220 may receive a request 265 for verification of authenticity of a product. As with request 130 of FIG. 1, each request 265 may be associated with a verification code 272 printed on a product 270 and location data identifying a physical location 250 of the product 270. Upon receipt of request 265 from a user computing device 260 at a given location 250, verification module 220 may determine whether the product 270 is authentic or otherwise legitimate based on a lookup of code 272 or application of a mathematical function to code 272. In some embodiments, verification module 220 may also determine whether product 270 is currently located within a permitted geographical area, as detailed above in connection with instructions 124 of FIG. 1. Verification module 220 may then record the code 272, physical location, and the verification result in verification history 216. Verification module 220 may also transmit a notification of the verification result 267 to the requesting user computing device 260, such that the customer may ascertain whether the product 270 is authentic at the point of sale.

Unauthorized region detection module 222 may include a number of sub-modules 224, 226, 228, 230 for analyzing each request 265 to determine whether the particular region 250 including the physical location of the product 270 is likely to be a region in which unauthorized products are available to consumers. In particular, detection module may include boundary determining module 224, request counting module 226, unauthorized region identifying module 228, and output module 230.

Boundary determining module 224 may vary depending on the particular embodiment. In embodiments in which module 222 identifies unauthorized regions using predetermined region data 217, determining module 224 may determine the boundaries for each location independently from the verification requests 265. For example, determining module 224 may analyze digital map data to identify the outer boundaries of each vendor or location and store coordinates corresponding to the identified outer boundaries. The number of coordinates used may vary depending on the complexity of the outer perimeter of the particular vendor or location. For example, four coordinates may be used when the outer boundary is a rectangle, while six coordinates may be used if the outer boundary is “L-shaped.” As an alternative to storing the coordinates, determining module 224 may instead store a single point and define the remainder of the boundary mathematically (e.g., based on a radius, two offsets representing the lengths of sides of a rectangle, etc.).

Alternatively, in embodiments in which module 222 identifies unauthorized regions using dynamic region data 218, determining module 224 may create and adjust boundaries based on the location data included with the verification requests 265. For example, determining module 224 may identify boundaries of a particular region by maximizing the number of invalid requests for verification included within the boundaries.

As a specific example, determining module 224 may construct a polygon with a predetermined maximal area in a manner that maximizes the number of invalid requests included in the boundaries of the polygon. More specifically, upon receipt of a particular verification request 265, module 224 may initially determine whether the physical location 250 falls within the polygonal boundaries of an existing location and, if so, add the request 265 to that boundary. Otherwise, module 224 may determine whether to expand an existing polygonal boundary to include the verification request 265, subject to a maximum boundary area, which may be a predetermined size roughly equal to the maximum anticipated size of a vendor or other location. Finally, module 224 may determine whether to create a new polygon boundary that includes the verification request 265. By iteratively repeating this process for each request, as detailed below in connection with method 450 of FIG. 4B, module 224 may dynamically construct a number of boundaries that group requests into regions that are likely to correspond actual vendor locations.

In some embodiments, determining module 224 may similarly group requests into regions based on a point-wise comparison using a statistical error attributable to the location data. For example, the statistical error may be a margin of error that can be assigned to a particular set of GPS coordinates. Determining module 224 may compare the coordinates of a group of requests and determine that the requests belong to the same boundary when the distance between each pair of points in the group is within the GPS error multiplied by some predetermined value.

Regardless of whether boundary determining module 224 uses predetermined region data 217 or dynamic region data 218, request counting module 226 may track the number of valid and invalid requests included within each boundary by accessing verification history 216. For example, counting module 226 may track, for each boundary, a total number of invalid requests for which the physical location 250 of the product 270 is within the boundary. Counting module 226 may also count a total number of valid requests for each boundary.

Unauthorized region identifying module 228 may identify, based on the results of request counting module 226, each region in which unauthorized products are likely available. For example, in some embodiments, identifying module 228 may determine that the boundary corresponds to a region likely to include unauthorized products when the total number of invalid requests meets a predetermined threshold. In some embodiments, identifying module 228 may further determine the degree of likelihood that the particular region has unauthorized products available. For example, a first threshold may correspond to a somewhat suspect vendor or location, a second threshold may correspond to a suspect vendor or location, a third threshold may correspond to a highly suspect vendor or location, etc. As an alternative, identifying module 228 may determine whether a particular region is likely to include unauthorized products based on a comparison of the number of invalid requests for the region to the number of valid requests to the region. For example, the percentage of invalid requests may be used to determine the degree of likelihood that a region includes unauthorized products.

Output module 230 may be configured to gather the results from unauthorized region identifying module 228 and output the results. These results may be outputted to a local or remote display, electronically transmitted to another computing device, or stored in storage module 215. The outputted data may be, for example, a map including a selected geographical area and an indication of locations in the geographical area that are likely to include unauthorized products. Alternatively, the outputted data may be a list of vendors or regions likely to include unauthorized products in a given geographical area. Other suitable formats for the output will be apparent to those of skill in the art.

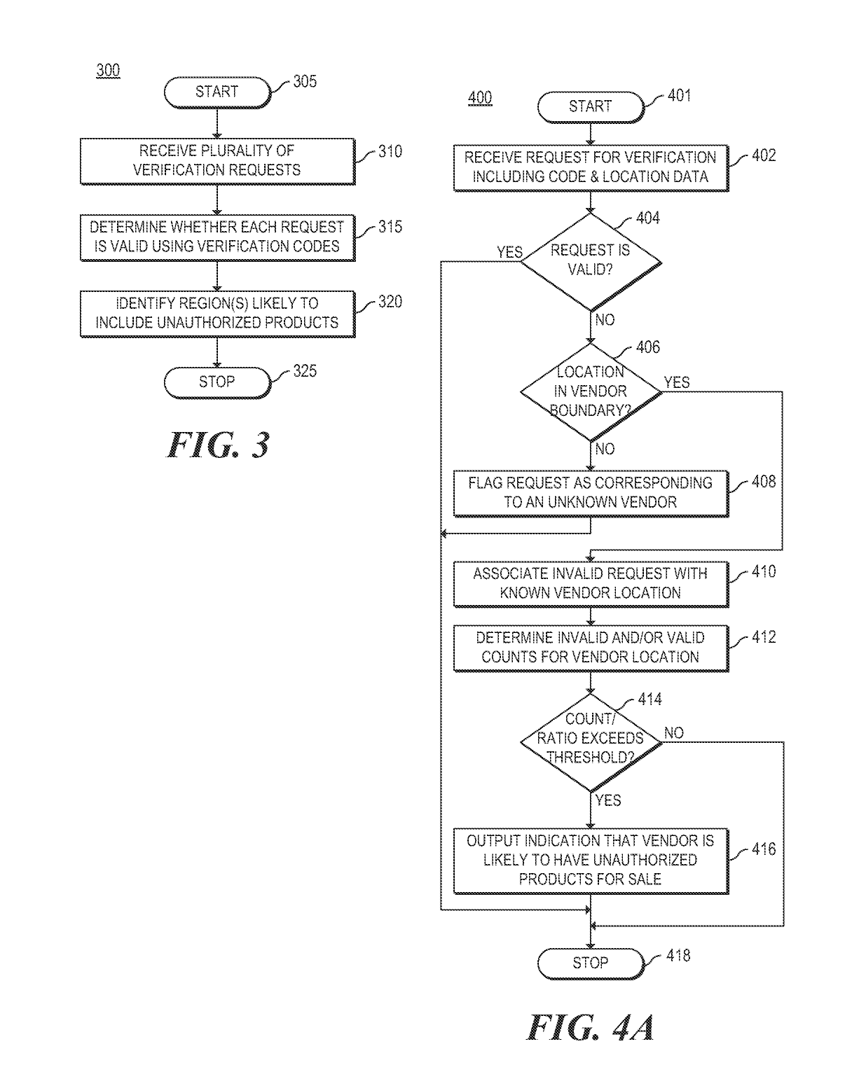

FIG. 3 is a flowchart of an example method 300 for identifying regions in which unauthorized products are available. Although execution of method 300 is described below with reference to computing device 100, other suitable components for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 starts in block 305 and proceeds to block 310, where computing device 100 may receive a plurality of verification requests. As detailed above, each request may be associated with a verification code corresponding to the product and location data identifying a physical location of the product.

Method 300 then proceeds to block 315, where computing device 100 may determine whether each request is valid. For example, computing device 100 may compare each verification code to a list of codes known to be valid or perform a mathematical operation to determine the validity of the code. In some embodiments, computing device 100 may also determine whether the product is currently located in a permitted geographical area. In this manner, computing device 100 may determine whether each corresponding product is authentic or, alternatively, is unauthorized and/or is located in an unauthorized area.

Finally, in block 320, computing device 100 may identify regions likely to include unauthorized products. For example, computing device 100 may predetermine location boundaries and determine a number of invalid requests that map to the predetermined boundaries. Alternatively, computing device 100 may dynamically construct boundaries. Computing device 100 may then determine, based on the number of invalid requests included in each boundary, whether the corresponding region is likely to include unauthorized products. Method 300 then proceeds to block 325, where method 300 stops.

FIGS. 4A and 4B are flowcharts of two alternative example methods for identifying regions in which unauthorized products are available. Although execution of methods 400, 450 are described below with reference to the components of computing device 200, other suitable components for execution of methods 400, 450 will be apparent to those of skill in the art. Methods 400, 450 may be implemented in the form of executable instructions stored on a machine-readable storage medium and/or in the form of electronic circuitry.

FIG. 4A is a flowchart of an example method 400 for identifying regions in which unauthorized products are available using predetermined boundaries. Method 400 starts in block 401 and proceeds to block 402, where computing device 200 may receive a request for verification 265 including a verification code and location data identifying the physical location of the product.

Method 400 then continues to block 404, where request verification module 220 may determine whether the request is valid based, for example, on a database lookup using the verification code. When it is determined that the request is valid, method 400 continues to block 418, where method 400 stops. Otherwise, when it is determined that the request is invalid, method 400 proceeds to block 406.

In block 406, boundary determining module 224 may determine whether the physical location corresponding to the invalid request falls within a predetermined boundary described in region data 217. If not, method 400 moves to block 408, where boundary determining module 224 may flag the invalid request as corresponding to an unknown location. A user of computing device 200 may subsequently view the flagged request and update region data 217 accordingly. After step 408, method 400 proceeds to block 418, where method 400 stops.

Alternatively, when, in block 406, boundary determining module 224 identifies a boundary that includes the invalid request, method 400 continues to block 410, where boundary determining module 224 associates the invalid request with a predetermined location in region data 217. In block 412, request counting module 226 may then determine the total number of invalid requests within the boundary and, in some embodiments, may also determine the total number of valid requests within the boundary.

Method 400 then continues to block 414, where unauthorized region identifying module 228 determines whether the boundary corresponds to a vendor or location likely to have unauthorized products. For example, in some embodiments, identifying module 228 may determine whether the total number of invalid requests exceeds a predetermined threshold. In other embodiments, identifying module 228 may compare the number of invalid and valid requests to determine whether the percentage of invalid requests exceeds a predetermined threshold. If one or both conditions are satisfied, method 400 proceeds to block 416, where output module 230 outputs an indication identifying the location and indicating that the location is likely to have unauthorized products for sale. Method 400 then proceeds to block 418, where method 400 stops. Alternatively, when identifying module 228 determines in block 414 that the location is not likely to have unauthorized products for sale, method 400 skips directly to block 418.

FIG. 4B is a flowchart of an example method 450 for identifying regions in which unauthorized products are available using dynamic region boundaries. Method 450 starts in block 452 and proceeds to block 454, where computing device 200 may receive a request for verification 265 including a verification code and location data identifying the physical location of the product.

Method 450 then continues to block 456, where request verification module 220 may determine whether the request is valid based, for example, on a database lookup using the verification code. When it is determined that the request is valid, method 450 continues to block 476, where method 450 stops. Otherwise, when it is determined that the request is invalid, method 450 proceeds to block 458.

In block 458, boundary determining module 224 may determine whether the physical location associated with the request falls within an existing boundary. For example, module 224 may traverse a number of data structures, each corresponding to a dynamic boundary in dynamic region data 218, to determine whether the request falls within a particular boundary. If so, method 450 continues to block 460, where boundary determining module 224 adds the invalid request to the existing boundary identified in block 458. Method 450 then continues to block 470, described in detail below.

Alternatively, when boundary determining module 224 determines in block 458 that the request does not fall within an existing boundary, method 450 continues to block 462, where module 224 determines whether to expand an existing boundary to include the invalid request. For example, module 224 may traverse the dynamic boundary data structures contained in dynamic region data 218 and identify the boundaries that could be expanded to include the invalid request, subject to a predetermined maximum area. When two or more boundaries could potentially be expanded to include the invalid request, module 224 may select the boundary to be expanded as the boundary for which the distance from the current boundary to the location associated with the request is the lowest. In this manner, module 224 may expand the boundary that most likely corresponds to the vendor or other location at which the invalid request originated.

When module 224 successfully identifies an existing boundary to be expanded, method 450 continues to block 464, where module 224 adjusts the corresponding boundary contained in dynamic region data 218 to include the newly-received invalid request. For example, boundary determining module 224 may minimally increase the size of the boundary such that the new boundary encompasses both the new request and all requests previously included in the boundary. In block 466, boundary determining module 224 may then associate the new invalid request with the existing boundary. Method 450 then proceeds to block 470, described in detail below.

Alternatively, when it is determined in block 462 that there is no existing boundary that can be expanded to include the new invalid request, method 450 proceeds to block 468. In block 468, boundary determining module 224 may create a new boundary including the location of the invalid request. For example, module 224 may create a boundary of a predetermined minimal size that is centered with respect to the new invalid request. Method 450 then continues to block 470.

In block 470, request counting module 226 determines the total number of invalid requests within the identified, expanded, or created boundary. In some embodiments, counting module 226 may also determine the total number of valid requests within the boundary.

Method 450 then continues to block 472, where unauthorized region identifying module 228 determines whether the dynamic boundary corresponds to a location likely to include unauthorized products. For example, identifying module 228 may determine whether the total number of invalid requests exceeds a predetermined threshold and/or compare the number of invalid and valid requests to determine whether the percentage of invalid requests exceeds a predetermined threshold. If one or both conditions are satisfied, method 450 proceeds to block 474, where output module 230 outputs an indication of the dynamic boundaries and an indication that a vendor or other entity operating within these boundaries is likely to have unauthorized products. Method 450 then proceeds to block 476, where method 450 stops. Alternatively, when identifying module 228 determines in block 472 that the location is not likely to include unauthorized products, method 450 skips directly to block 476.

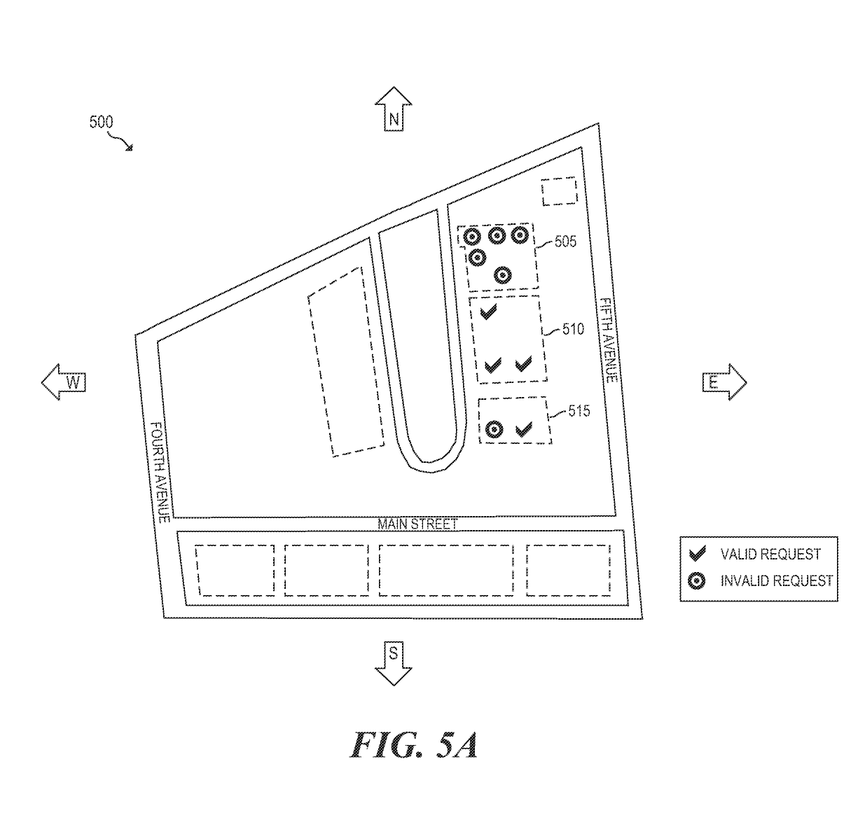

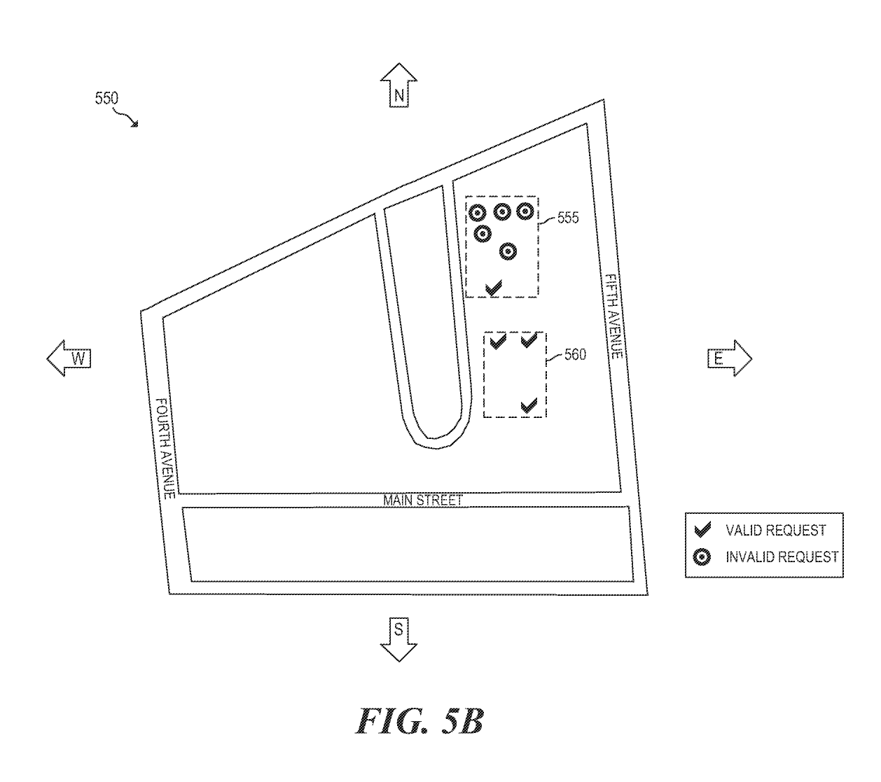

FIG. 5A is a diagram 500 illustrating example predetermined vendor boundaries and a plurality of corresponding verification requests. As described above in connection with region data 217 and method 400 of FIG. 4A, some embodiments disclosed herein detect vendors or other locations likely to have unauthorized products using predetermined vendor boundaries.

Accordingly, FIG. 5A illustrates a number of predetermined boundaries, including a first vendor 505, a second vendor 510, and a third vendor 515. As illustrated, the perimeter of first vendor 505 encompasses five invalid requests and the first vendor 505 is therefore likely to be a vendor offering unauthorized products. In contrast, the perimeter of second vendor 510 includes only valid requests, while the perimeter of third vendor 515 includes one invalid request and one valid request.

FIG. 5B is a diagram 550 illustrating example dynamic vendor boundaries and a plurality of corresponding verification requests. As described above in connection with dynamic region data 218 and method 450 of FIG. 4B, some embodiments disclosed herein detect vendors or other locations likely to include unauthorized products using dynamic boundaries constructed based on the requests received.

Thus, in contrast to FIG. 5A, FIG. 5B illustrates two dynamic boundaries 555, 560 constructed based on the receipt of verification requests from a user's computing device. First dynamic boundary 555 corresponds to a first area including five invalid requests and one valid request. Thus, a vendor located in a geographical area roughly corresponding to the perimeter of boundary 555 is likely to have unauthorized products available to consumers. Similarly, second dynamic boundary 560 corresponds to a second area including three valid requests. Thus, a vendor located in a geographical area roughly corresponding to the perimeter of boundary 560 is likely a legitimate vendor that does not offer unauthorized products to consumers.

According to the foregoing, example embodiments disclosed herein allow for detection of regions likely to include unauthorized products. For example, as described above, a computing device may utilize predetermined boundaries or dynamic region boundaries to identify a number of invalid verification requests with a physical location within a given boundary. In this manner, example embodiments allow for a manufacturer or other entity to identify locations likely to include unauthorized products with minimal effort.

What is claimed is:

1. A computing device for identifying regions in which unauthorized products are available, the computing device comprising:
a processor; and
a memory including instructions that, when executed, cause the processor to:
access a request for verification of authenticity of a product, the request transmitted from a remote computing device, the request including verification data and location data, the verification data indicative of a verification code printed on the product, the location data indicative of a physical location of the product, the location data based on global positioning satellite information generated by the remote computing device at a time when the remote computing device generates the verification data based on the verification code;
determine, based on analysis of the request and a plurality of previous requests received via a network from other remote computing devices, whether a particular region including the physical location identified by the location data has at least a threshold likelihood of being a region in which unauthorized products are available; and
construct boundaries of the particular region to 1) have less than a first area and 2) circumscribe locations from which at least a threshold number of invalid requests for verification are received, the invalid requests including verification data that does not match valid codes stored in a database, the constructed boundaries indicative of a geographic area in which a vendor is selling unauthorized products.

2. The computing device of claim 1, wherein the verification code is a barcode.

3. The computing device of claim 1, wherein the instructions are further to cause the processor to determine whether the request for verification of authenticity is valid by:
matching the verification data to the valid codes stored in the database; and
determining, using the location data, whether the product is currently located within a permitted geographical area.

4. The computing device of claim 3, wherein the instructions are to cause the processor to determine that the particular region including the physical location has at least the threshold likelihood of being a region in which unauthorized products are available when a total number of invalid requests for verification within the particular region satisfies a threshold.

5. The computing device of claim 4, wherein the instructions are to cause the processor to determine a degree of likelihood that the particular region has unauthorized products based on the total number of invalid requests for verification.

6. The computing device of claim 1, wherein the threshold number of invalid requests is a maximum possible number of invalid requests that can be included within the boundaries of the particular region while the particular region remains less than the first area.

7. The computing device of claim 1, wherein the instructions are to cause the processor to construct the boundaries by constructing a polygon having a predetermined area.

8. The computing device of claim 1, further including:
storage to store boundaries for a plurality of locations, the instructions to cause the processor to identify locations having at least the threshold likelihood of having unauthorized products by counting a total number of invalid requests for which the physical location of the product is within a boundary for a corresponding location.

9. A machine-readable storage device encoded with instructions which, when executed by a processor, cause the processor to at least:
access a plurality of requests, each request for verification of authenticity of a corresponding product received via a network from a remote computing device, each request including verification data and location data, the verification data indicative of a verification code printed on the product, the location data indicative of a physical location of the product, the location data based on global positioning satellite information generated by the corresponding remote computing device at a time when the remote computing device generates the verification data based on the verification code;
determine whether each request is valid using the verification data included with the request;
identify regions having at least a threshold likelihood of including unauthorized products by grouping invalid requests into regions based on the physical location identified by the location data included with each request, the invalid requests including verification data that does not match valid codes stored in a database; and
construct boundaries of a first one of the regions to 1) circumscribe locations from which a maximum number of invalid requests for verification are received while 2) the first one of the regions has less than a first area, the constructed boundaries indicative of a geographic area in which a vendor is selling unauthorized products.

10. The machine-readable storage device of claim 9, wherein the instructions are to cause the processor to identify the regions by identifying locations having at least a threshold likelihood of having unauthorized products based on a number of invalid requests for which the physical location of the product is within a boundary for a corresponding location.

11. The machine-readable storage device of claim 9, wherein the instructions are to cause the processor to group the invalid requests into the regions based on a statistical error attributable to the location data.

12. A method for identifying regions in which unauthorized products are available, the method comprising:
receiving a request for verification of a product, the request transmitted from a remote computing device, the request including verification data and location data, the verification data indicative of a verification code printed on the product, the location data indicative of a physical location of the product, the location data based on global positioning satellite information generated by the remote computing device at a time when the remote computing device generates the verification data based on the verification code;
determining, by executing an instruction with a processor, whether the request is valid using the verification data associated with the verification code corresponding to the product;
determining, by executing an instruction with the processor, whether a particular region that includes the physical location identified by the location data is a region having at least a threshold likelihood of including unauthorized products based on a number of invalid requests received from the remote computing device and other remote computing devices within the particular region, the invalid requests including verification data that does not match valid codes stored in a database; and
constructing, by executing an instruction with the processor, boundaries of the particular region to 1) have less than a first area and 2) circumscribe locations from which at least a threshold number of invalid requests for verification are received, the constructed boundaries indicative of a geographic area in which a vendor is selling unauthorized products.

13. The method of claim 12, wherein determining whether the particular region is the region having at least the threshold likelihood of including unauthorized products includes determining that the number of invalid requests for verification included within the boundaries satisfied a threshold.

14. The method of claim 12, further including determining whether a second region has at least the threshold likelihood of including unauthorized products by:
counting a total number of invalid requests corresponding to a physical location within a predetermined boundary corresponding to a particular location; and
determining that the second region has at least a threshold likelihood of including unauthorized products when the total number of invalid requests within the predetermined boundary satisfies a threshold.

15. The method of claim 12, wherein determining whether the particular region has at least a threshold likelihood of including unauthorized products is based on a comparison of the number of invalid requests received for the particular region to a number of valid requests received for the particular region.

16. The method of claim 12, wherein the threshold number of invalid requests is a maximum possible number of invalid requests that can be included within the boundaries while the particular region within the boundaries has less than the first area.
